(19) United States
(12) Patent Application Publication
(10) Pub. No.: US 2023/0303597 A1
(43) Pub. Date: Sep. 28, 2023

(54) METAL-LIGAND COMPLEX, CATALYST COMPOSITION FOR PREPARING ETHYLENE-BASED POLYMER CONTAINING THE SAME, AND PREPARATION METHOD OF ETHYLENE -BASED POLYMER USING THE SAME

(71) Applicant: SABIC SK NEXLENE COMPANY PTE. LTD., Singapore (SG)

(72) Inventors: Dongcheol Shin, Daejeon (KR); Miji Kim, Daejeon (KR); Minji Kim, Daejeon (KR)

(21) Appl. No.: 18/041,016

(22) PCT Filed: Dec. 13, 2021
(86) PCT No.: PCT/IB2021/061605

§ 371 Date: Feb. 8, 2023

(30) Foreign Application Priority Data
Dec. 28, 2020 (KR) 10-2020-0184595
Dec. 9, 2021 (KR) 10-2021-0175570

(51) Int. Cl. C07F 7/28; C08F 4/64; C08F 210/16

(52) U.S. Cl. CPC C07F 7/28; C08F 4/64193; C08F 210/16

(57) ABSTRACT

Provided are a metal-ligand complex having both a strong electron donor group and an electron withdrawing group by introducing a specific functional group, difluoromethylene group, into an oxygen-oxygen bridge, a catalyst composition for ethylene-based polymerization containing the same, and a preparation method of an ethylene-based polymer using the same. The metal-ligand complex according to the present invention and the catalyst composition containing the same may be very usefully used in the preparation of an ethylene-based polymer having excellent physical properties.

### TECHNICAL FIELD

The following disclosure relates to a metal-ligand complex, a catalyst composition for preparing an ethylene-based polymer containing the same, and a preparation method of an ethylene-based polymer using the same.

### BACKGROUND ART

Conventionally, in the preparation of an ethylene-based polymer such as a copolymer of ethylene and α-olefin or a copolymer of ethylene and olefin-diene, a so-called, a Ziegler-Natta catalyst system, which generally includes a main catalyst component of a titanium or vanadium compound, and a cocatalyst component of an alkyl aluminum compound, has been used.

U.S. Pat. Nos. 3,594,330 and 3,676,415 disclose improved Ziegler-Natta catalysts. However, though the Ziegler-Natta catalyst system exhibits high activity to ethylene polymerization, it has a disadvantage in that generally a produced polymer has a broad molecular weight distribution due to a heterogeneous catalyst active site, and in particular copolymers of ethylene and α-olefins have a non-uniform composition distribution.

Thereafter, various studies have been conducted on a metallocene catalyst system including a metallocene compound of transition metals of Group 4 in the periodic table such as zirconium and hafnium, and methylaluminoxane as a cocatalyst, wherein the metallocene catalyst system is a homogeneous catalyst having a single catalyst activity site and may prepare polyethylene having a narrow molecular weight distribution and a uniform composition distribution as compared with the conventional Ziegler-Natta catalyst system.

For example, European Patent Publication Nos. 320,762 and 372,632 disclose that a metallocene compound may be activated with cocatalyst methyl aluminoxane in Cp₂ TiCl₂, Cp₂ZrCl₂, Cp₂ZrMeCl, Cp₂ZrMe₂, ethylene(IndH₄)₂ZrCl₂, etc., to polymerize ethylene with high activity, thereby preparing polyethylene having a molecular weight distribution (Mw/Mn) in a range of 1.5 to 2.0.

A low density and low molecular weight ethylene-based polymer prepared with ethylene or by polymerization of ethylene and α-olefin may be applied to the development of high value-added products such as a synthetic oil, a lubricant, and an adhesive.

However, when the catalyst system is applied, it is difficult to obtain a low density and low molecular weight ethylene-based polymer. That is, most of the low density and low molecular weight ethylene-based polymers are produced at a temperature of less than 100° C. and exhibit rapidly lower activity as the temperature increases. In addition, hydrogen is used as a chain transfer agent to prepare a low molecular weight ethylene-based polymer. However, since the catalytic activity rapidly decreases as the amount of hydrogen used increases, there is a problem in that it is difficult to prepare the low molecular weight ethylene-based polymer at a high temperature and the catalytic activity is low.

Therefore, catalysts and catalyst precursors having desired improved properties are still required in the chemical industry.

### DISCLOSURE OF INVENTION

### Technical Problem

An embodiment of the present invention is directed to providing a metal-ligand complex in which difluoromethylene, which is a specific substituent, is introduced as a bridge, and a catalyst composition for preparing an ethylene-based polymer containing the same, in order to alleviate the conventional problems.

Another embodiment of the present invention is directed to providing a preparation method of a low density and low molecular weight ethylene-based polymer using the catalyst composition for preparing an ethylene-based polymer according to the present invention.

### Solution to Problem

In one general aspect, there is provided a metal-ligand complex represented by the following Formula 1, the metal-ligand complex having significantly improved high-temperature activity due to increased stability at a high temperature by introducing a specific functional group:

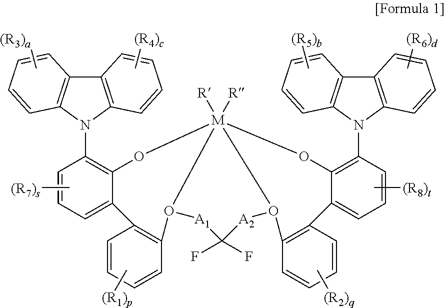

wherein
M is a transition metal of Group 4 in the periodic table;
A₁ and A₂ are each independently C₁-C₂₀alkylene or C₁-C₂₀haloalkylene;
R′ and R″ are each independently C₁-C₂₀alkyl, C₆-C₂₀aryloxy, or C₁-C₂₀alkylC₆-C₂₀ aryloxy;
R₁ and R₂ are each independently halogen, C₁-C₂₀alkyl, or haloC₁-C₂₀alkyl;
R₃ to R₆ are each independently C₁-C₂₀alkyl, C₆-C₂₀aryl, or C₆-C₂₀arylC₁-C₂₀alkyl;
R₇ and R₈ are each independently C₁-C₂₀alkyl or C₁-C₂₀alkoxy;
p, q, a, b, c, and d are each independently an integer from 0 to 4; and
s and t are each independently an integer from 0 to 3.

In another general aspect, there is provided a catalyst composition for preparing an ethylene-based polymer containing the metal-ligand complex according to the present invention and a cocatalyst.

In still another general aspect, there is provided a preparation method of an ethylene-based polymer, including: preparing an ethylene-based polymer by polymerizing ethylene or ethylene and α-olefin in the presence of the catalyst composition for preparing an ethylene-based polymer as described above.

### Advantageous Effects of Invention

The metal-ligand complex according to the present invention has a structure of an electron donor-acceptor with a phenyl group substituted with a carbazole group, which is a strong electron donor group, by introducing a difluoromethylene group as a specific functional group as an oxygen-oxygen bridge. Due to such structural characteristics, the electrons of the ligand in the complex are enriched and the stability of the complex is remarkably improved, so that polymerization may be promoted at a high polymerization temperature without deterioration of catalytic activity.

In addition, the metal-ligand complex according to the present invention has the advantages of being able to easily polymerize due to excellent reactivity with olefins, and preparing a low density and low molecular weight ethylene-based polymer at a high polymerization temperature.

In particular, when the catalyst composition containing a metal-ligand complex according to the present invention is used in the preparation of an ethylene-based polymer, that is, an ethylene homopolymer or a copolymer of ethylene and α-olefin, it is possible to efficiently prepare a low density and low molecular weight ethylene homopolymer or a copolymer of ethylene and α-olefin with excellent catalytic activity at a high polymerization temperature of 100° C. or more.

This results from the structural characteristics of the metal-ligand complex according to the present invention. Since the metal-ligand complex according to the present invention has excellent copolymerization reactivity with olefins while maintaining high catalytic activity even at a high temperatures due to the excellent thermal stability to the catalyst and may prepare a low density and low molecular weight ethylene-based polymers in high yield, it may be said to have higher commercial practicality such as application to the development of a number of high value-added products such as a synthetic oil, a lubricant, and an adhesive compared to known metallocene- and a non-metallocene-based single activity site catalysts.

Thus, the metal-ligand complex according to the present invention and the catalyst composition containing the same may be very usefully used in the preparation of an ethylene-based polymer having excellent physical properties.

### MODE FOR THE INVENTION

Hereinafter, the present invention will describe a metal-ligand complex according to the present invention, a catalyst composition for preparing an ethylene-based polymer containing the same, and a preparation method of an ethylene-based polymer using the same, but technical terms and scientific terms used herein have the general meaning understood by those skilled in the art to which the present invention pertains unless otherwise defined, and a description for the known function and configuration obscuring the present invention will be omitted in the following description.

As used herein, the following terms are defined as follows, but are merely exemplary and are not intended to limit the present invention, application, or use.

As used herein, the terms “substituent”, “radical”, “group”, “group”, “moiety”, and “fragment” may be interchangeably used.

As used herein, the term “C_{A}-C_{B}” means “the number of carbon atoms is greater than or equal to A and less than or equal to B”.

As used herein, the term “alkyl” refers to a linear or branched saturated monovalent hydrocarbon radical composed only of carbon and hydrogen atoms. The alkyl may have 1 to 20 carbon atoms, 1 to 10 carbon atoms, 1 to 5 carbon atoms, 5 to 20 carbon atoms, 8 to 20 carbon atoms or 8 to 15 carbon atoms, but the present invention is not limited thereto. Specific examples of the alkyl include, but are not limited to, methyl, ethyl, n-propyl, isopropyl, n-butyl, sec-butyl, i-butyl, t-butyl, pentyl, i-pentyl, methylbutyl, n-hexyl, t-hexyl, methylpentyl, dimethylbutyl, heptyl, ethylpentyl, methylhexyl, dimethylpentyl, n-octyl, t-octyl, dimethylhexyl, ethylhexyl, n-decyl, t-decyl, n-dodecyl, t-dodecyl, etc.

As used herein, the term “aryl” refers to a monovalent organic radical derived from an aromatic hydrocarbon by removal of one hydrogen, and includes a monocyclic or fused ring system containing suitably 4 to 7, preferably 5 or 6 ring atoms in each ring, and even a form in which a plurality of aryls are connected by a single bond. Specific examples of the aryl include, but are not limited to, phenyl, naphthyl, biphenyl, fluorenyl, phenanthrenyl, anthracenyl, triphenylenyl, pyrenyl, chrysenyl, naphthacenyl, etc.

As used herein, the term “alkoxy” refers to an —O-alkyl radical, where “alkyl” is as defined above. Specific examples of the alkoxy include, but are not limited to, methoxy, ethoxy, isopropoxy, butoxy, isobutoxy, t-butoxy, etc.

As used herein, the term “aryloxy” refers to an —O-aryl radical, where “aryl” is as defined above. Specific examples of the aryloxy include, but are not limited to, phenoxy, naphthoxy, etc.

As used herein, the term “alkylaryl” refers to an aryl radical substituted with at least one alkyl, where “alkyl” and “aryl” are as defined above. Specific examples of the alkylaryl include, but are not limited to, tolyl, etc.

As used herein, the term “arylalkyl” refers to an alkyl radical substituted with at least one aryl, where “alkyl” and “aryl” are as defined above. Specific examples of the arylalkyl include, but are not limited to, benzyl, etc.

The present invention relates to a difluoromethyl-bridged metal-ligand complex as a bulky electron-withdrawing group, and provides a metal-ligand complex represented by the following Formula 1, including a carbazole group, which is a strong electron donor group introduced at a specific position, and a difluoromethylene group as an oxygen-oxygen bridge:

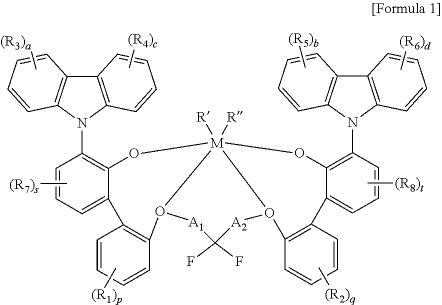

wherein
M is a transition metal of Group 4 in the periodic table;
A₁ and A₂ are each independently C₁-C₂₀alkylene or C₁-C₂₀haloalkylene;
R′ and R″ are each independently C₁-C₂₀alkyl, C₆-C₂₀aryloxy, or C₁-C₂₀alkylC₆-C₂₀ aryloxy;
R₁ and R₂ are each independently halogen, C₁-C₂₀alkyl, or haloC₁-C₂₀alkyl;
R₃ to R₆ are each independently C₁-C₂₀alkyl, C₆-C₂₀aryl, or C₆-C₂₀arylC₁-C₂₀alkyl;
R₇ and R₈ are each independently C₁-C₂₀alkyl or C₁-C₂₀alkoxy;
p, q, a, b, c, and d are each independently an integer from 0 to 4; and
s and t are each independently an integer from 0 to 3.

The metal-ligand complex according to the present invention may introduce a functional group including difluoromethylene as a bulky electron-withdrawing group to form an electron donor-acceptor structure with a phenyl group substituted with a carbazole group, which is an electron donor group to enrich the electrons of the ligand, thereby significantly improving the stability of the complex.

Therefore, the metal-ligand complex according to the present invention has excellent polymerization reactivity with other olefins while maintaining high catalytic activity even at a high temperatures due to the excellent thermal stability and may prepare a density and low molecular weight ethylene-based polymers in high yield, and thus has higher commercial practicality in the development of a number of high value-added products such as a synthetic oil, a lubricant, and an adhesive, compared to known metallocene- and a non-metallocene-based single activity site catalysts.

Preferably, in Formula 1 according to an exemplary embodiment of the present invention, A₁ and A₂ may be each independently C₁-C₂₀alkylene; R′ and R″ may be each independently C₁-C₂₀alkyl; R₁ and R₂ may be each independently halogen, C₁-C₂₀ alkyl, or haloC₁-C₂₀alkyl; R₃ to R₆ may be each independently C₁-C₂₀alkyl or C₆-C₂₀ arylC₁-C₂₀alkyl; R₇ and R₈ may be each independently C₁-C₂₀alkyl or C₁-C₂₀alkoxy; p and q may be each independently an integer from 0 to 3; a, b, c, and d may be each independently an integer from 1 to 3; and s and t may be each independently an integer from 1 to 2. More preferably, M may be titanium, zirconium, or hafnium; A₁ and A₂ may be each independently C₁-C₁₀alkylene; R′ and R″ may be each independently C₁-C₁₀alkyl; R₁ and R₂ may be each independently halogen, C₁-C₁₀alkyl, or haloC₁-C₁₀alkyl; R₃ to R₆ may be each independently C₁-C₁₀alkyl or C₆-C₂₀arylC₁-C₂₀alkyl; R₇ and R₈ may be each independently C₅-C₂₀alkyl or C₅-C₂₀alkoxy; p and q may be each independently an integer from 0 to 3; a, b, c, and d may be each independently an integer from 1 to 3; and s and t may be each independently an integer from 1 to 2.

In one embodiment, the R′ and R″ may be each independently C₁-C₇alkyl or C₁-C₃ alkyl.

In one embodiment, R₃ to R₆ may be each independently branched C₃-C₁₀alkyl or branched C₃-C₇alkyl.

In one embodiment, R₇ and R₈ may be each independently C₈-C₂₀alkyl, specifically n-octyl, t-octyl, n-nonyl, t-nonyl, n-decyl, t-decyl, n-undecyl, t-undecyl, n-dodecyl, or t-dodecyl.

In one embodiment, R₁ and R₂ may be each independently halogen or C₁-C₁₀alkyl, and p and q may be each independently an integer from 1 or 2.

In terms of having more improved thermal stability and excellent catalytic activity, preferably, the metal-ligand complex according to an exemplary embodiment of the present invention may be represented by the following Formula 2:

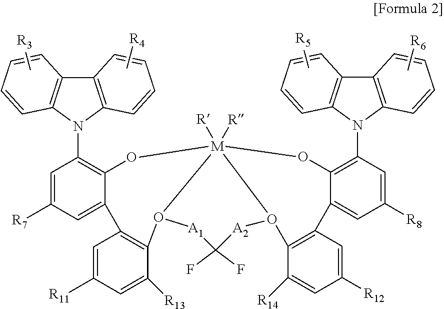

wherein
M is a transition metal of Group 4 in the periodic table;
A₁ and A₂ are each independently C₁-C₂₀alkylene or C₁-C₂₀haloalkylene;
R′ and R″ are each independently C₁-C₂₀alkyl, C₆-C₂₀aryloxy, or C₁-C₂₀alkylC₆-C₂₀ aryloxy;
R₃ to R₆ are each independently C₁-C₂₀alkyl, C₆-C₂₀aryl, or C₆-C₂₀arylC₁-C₂₀alkyl;
R₇ and R₈ are each independently C₁-C₂₀alkyl or C₁-C₂₀alkoxy;
R₁₁ and R₁₂ are each independently hydrogen, halogen, or C₁-C₂₀alkyl; and
R₁₃ and R₁₄ are each independently hydrogen or C₁-C₂₀alkyl.

Preferably, in Formula 2 according to an exemplary embodiment of the present invention, A₁ and A₂ may be each independently C₁-C₂₀alkylene; R′ and R″ may be each independently C₁-C₂₀alkyl; R₃ to R₆ may be each independently C₁-C₂₀alkyl or C₆-C₂₀arylC₁-C₂₀alkyl; R₇ and R₈ may be each independently C₁-C₂₀alkyl or C₁-C₂₀alkoxy; R₁₁ and R₁₂ may be each independently halogen; and R₁₃ and R₁₄ may be each independently hydrogen or C₁-C₂₀alkyl. More preferably, A₁ and A₂ may be each independently C₁-C₁₀alkylene; R′ and R″ may be each independently C₁-C₁₀alkyl; R₃ to R₆ may be each independently C₁-C₁₀alkyl; R₇ and R₈ may be each independently C₅-C₂₀ alkyl or C₅-C₂₀alkoxy; R₁₁ and R₁₂ may be each independently halogen; and R₁₃ and R₁₄ may be each independently hydrogen or C₁-C₁₀alkyl.

In one embodiment, the R′ and R″ may be each independently C₁-C₇alkyl or C₁-C₃ alkyl.

In one embodiment, R₃ to R₆ may be each independently branched C₃-C₁₀alkyl or branched C₃-C₇alkyl.

In one embodiment, R₇ and R₈ may be each independently C₈-C₂₀alkyl, and specifically, n-octyl, t-octyl, n-nonyl, t-nonyl, n-decyl, t-decyl, n-undecyl, t-undecyl, n-dodecyl, or t-dodecyl.

In one embodiment, both R₁₁ and R₁₂ may be fluoro.

More preferably, the metal-ligand complex according to an exemplary embodiment of the present invention may be represented by the following Formula 3:

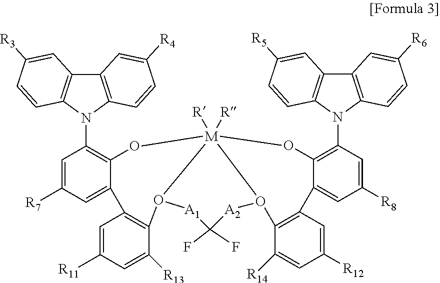

wherein
M is titanium, zirconium, or hafnium;
A₁ and A₂ are each independently C₁-C₂₀alkylene or C₁-C₂₀haloalkylene;
R′ and R″ are each independently C₁-C₂₀alkyl;
R₃ to R₆ are each independently C₁-C₂₀alkyl;
R₇ and R₈ are each independently C₁-C₂₀alkyl or C₁-C₂₀alkoxy;
R₁₁ and R₁₂ are each independently halogen; and
R₁₃ and R₁₄ are each independently hydrogen or C₁-C₂₀alkyl.

More preferably, in Formula 3 according to an exemplary embodiment of the present invention, A₁ and A₂ may be each independently C₁-C₁₀alkylene; R′ and R″ may be each independently C₁-C₁₀alkyl; R₃ to R₆ are each independently C₁-C₁₀alkyl; R₇ and R₈ may be each independently C₅-C₂₀alkyl or C₅-C₂₀alkoxy; R₁₁ and R₁₂ may be each independently halogen; and R₁₃ and R₁₄ may be each independently hydrogen or C₁-C₁₀ alkyl.

In one embodiment, the R′ and R″ may be each independently C₁-C₇alkyl or C₁-C₃ alkyl.

In one embodiment, R₃ to R₆ may be each independently branched C₃-C₁₀alkyl or branched C₃-C₇alkyl.

In one embodiment, R₇ and R₈ may be each independently C₈-C₂₀alkyl, and specifically, n-octyl, t-octyl, n-nonyl, t-nonyl, n-decyl, t-decyl, n-undecyl, t-undecyl, n-dodecyl, or t-dodecyl.

In one embodiment, both R₁₁ and R₁₂ may be fluoro.

Preferably, the metal-ligand complex according to an exemplary embodiment of the present invention may be represented by the following Formula 4:

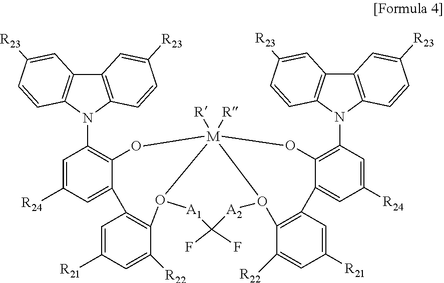

wherein
M is titanium, zirconium, or hafnium;
A₁ and A₂ are each independently C₁-C₂₀alkylene or C₁-C₂₀haloalkylene;
R is C₁-C₂₀alkyl;
R₂₁ is halogen;
R₂₂ is hydrogen or C₁-C₂₀alkyl;
R₂₃ is C₁-C₂₀alkyl;
R₂₄ is C₁-C₂₀alkyl or C₁-C₂₀alkoxy.

More preferably, in Formula 4 according to an exemplary embodiment of the present invention, M is titanium, zirconium or hafnium; A₁ and A₂ are each independently C₁-C₁₀alkylene; R is C₁-C₁₀alkyl; R₂₁ is halogen; R₂₂ is hydrogen or C₁-C₂₀alkyl; R₂₃ is C₁-C₁₀alkyl; and R₂₄ is C₅-C₂₀alkyl.

In one embodiment, the R may be C₁-C₇alkyl or C₁-C₃alkyl.

In one embodiment, R₂₃ may be branched C₃-C₁₀alkyl or branched C₃-C₇alkyl.

In one embodiment, R₂₄ may be C₈-C₂₀alkyl, and specifically, n-octyl, t-octyl, n-nonyl, t-nonyl, n-decyl, t-decyl, n-undecyl, t-undecyl, n-dodecyl, or t-dodecyl.

In one embodiment, R₂₁ may be fluoro.

In terms of further improving high-temperature stability, catalytic activity, and reactivity with olefins, the metal-ligand complex of Formula 1 according to an exemplary embodiment of the present invention may be represented by the following Formula 5:

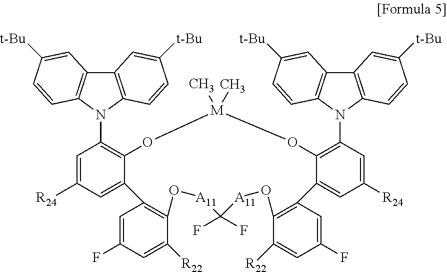

wherein
M is zirconium or hafnium;
A₁₁ is C₁-C₂₀alkylene;
R₂₄ is C₈-C₂₀alkyl; and
R₂₂ is hydrogen or methyl.

Preferably, in Formula 5 according to an exemplary embodiment of the present invention, R₂₄ may be C₈-C₁₂alkyl, and specifically, n-octyl, t-octyl, n-nonyl, t-nonyl, n-decyl, t-decyl, n-undecyl, t-undecyl, n-dodecyl, or t-dodecyl.

Preferably, in Formula 5 according to an exemplary embodiment of the present invention, A₁₁ may be C₁-C₁₀alkylene, C₁-C₇alkylene, or C₁-C₃alkylene.

In one embodiment, in Formula 5, A₁₁ may be —CH₂—; R₂₄ may be n-octyl, t-octyl, n-decyl, or n-dodecyl; and R₂₂ may be hydrogen.

In one embodiment, in Formula 5, A₁₁ may be —CH₂CH₂—; R₂₄ may be n-octyl, t-octyl, n-decyl, or n-dodecyl; and R₁₄ may be hydrogen.

In one embodiment, in Formula 5, A₁₁ may be —CH₂—; R₂₄ may be n-octyl, t-octyl, n-decyl, or n-dodecyl; and R₂₂ may be methyl.

In one embodiment, in Formula 5, A₁₁ may be —CH₂CH₂—; R₂₄ may be n-octyl, t-octyl, n-decyl, or n-dodecyl; and R₂₂ may be methyl.

Specifically, the metal-ligand complex according to an exemplary embodiment of the present invention may be a compound selected from the following structures, but the present invention is not limited thereto.

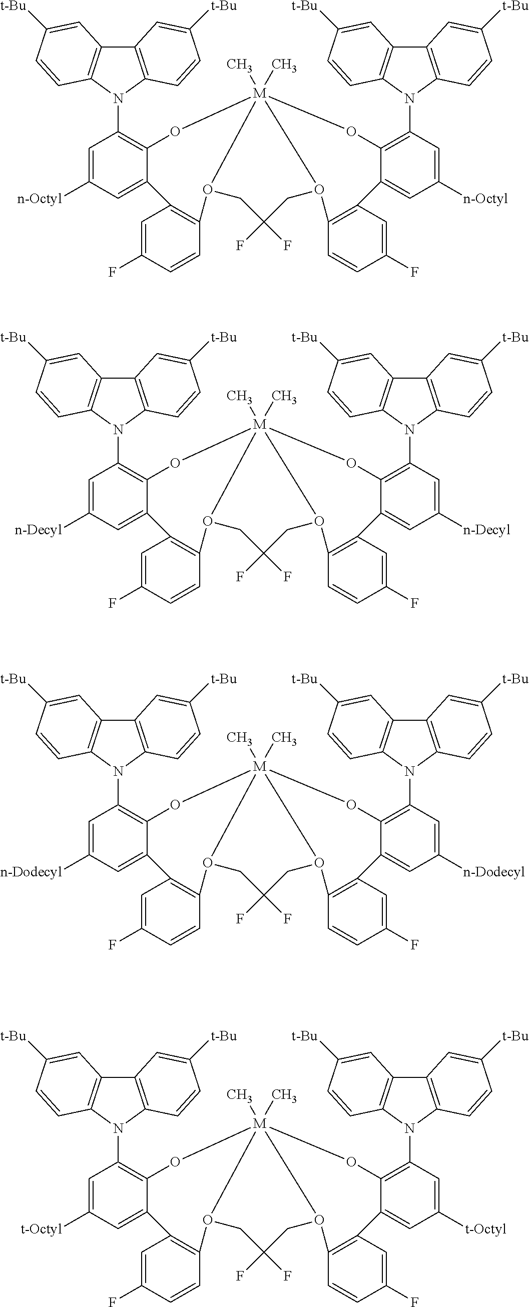

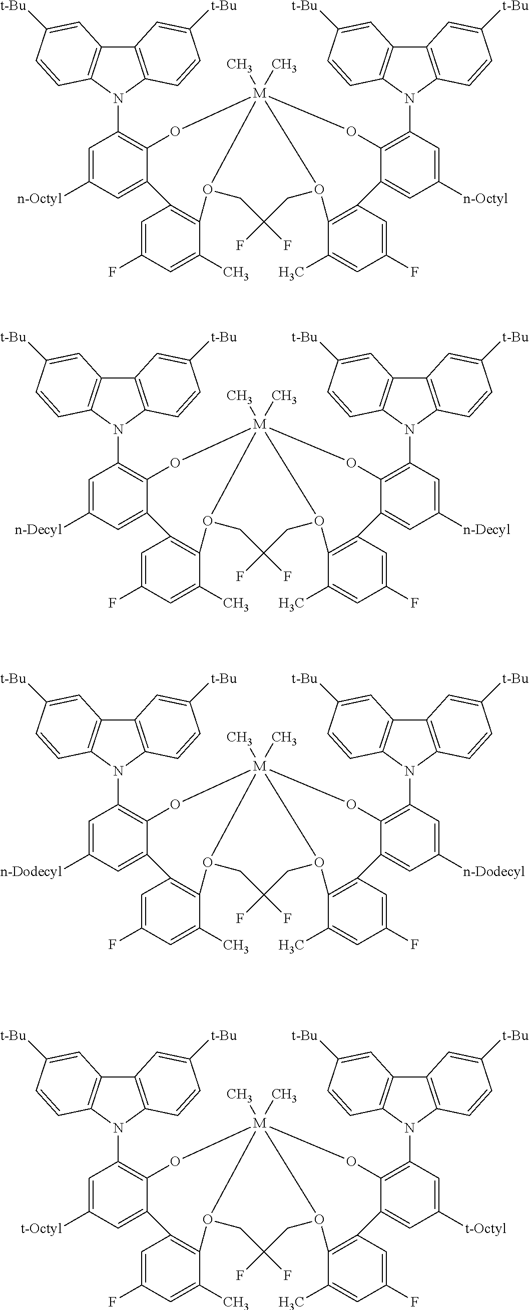

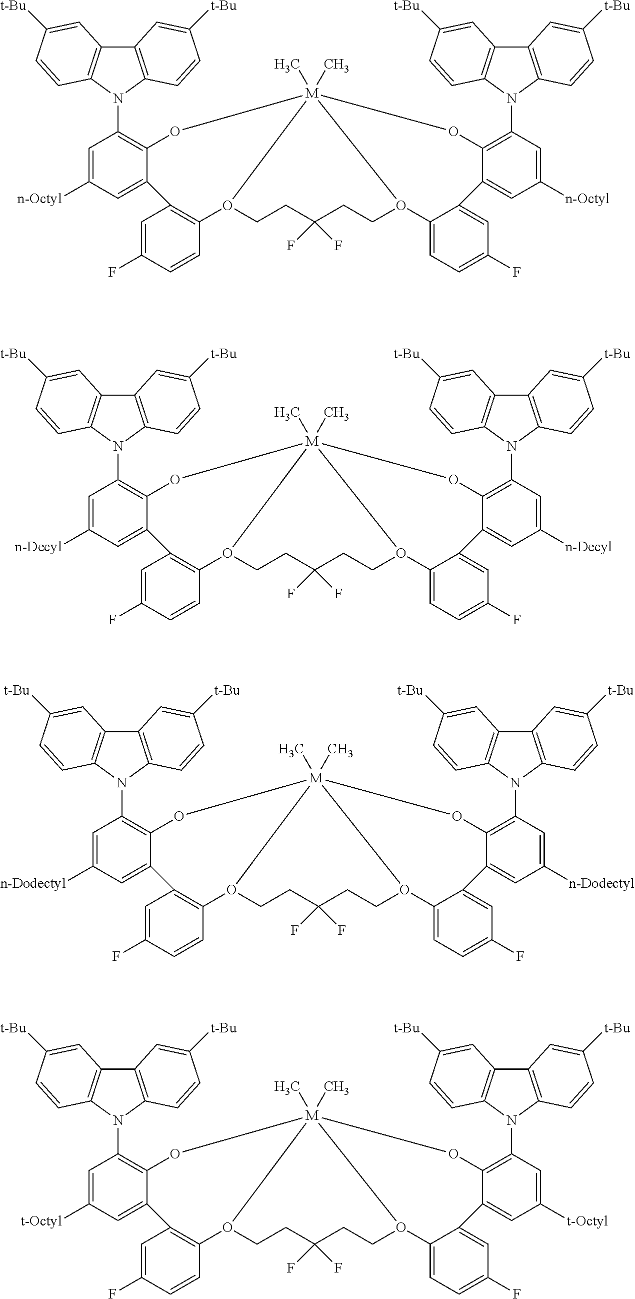

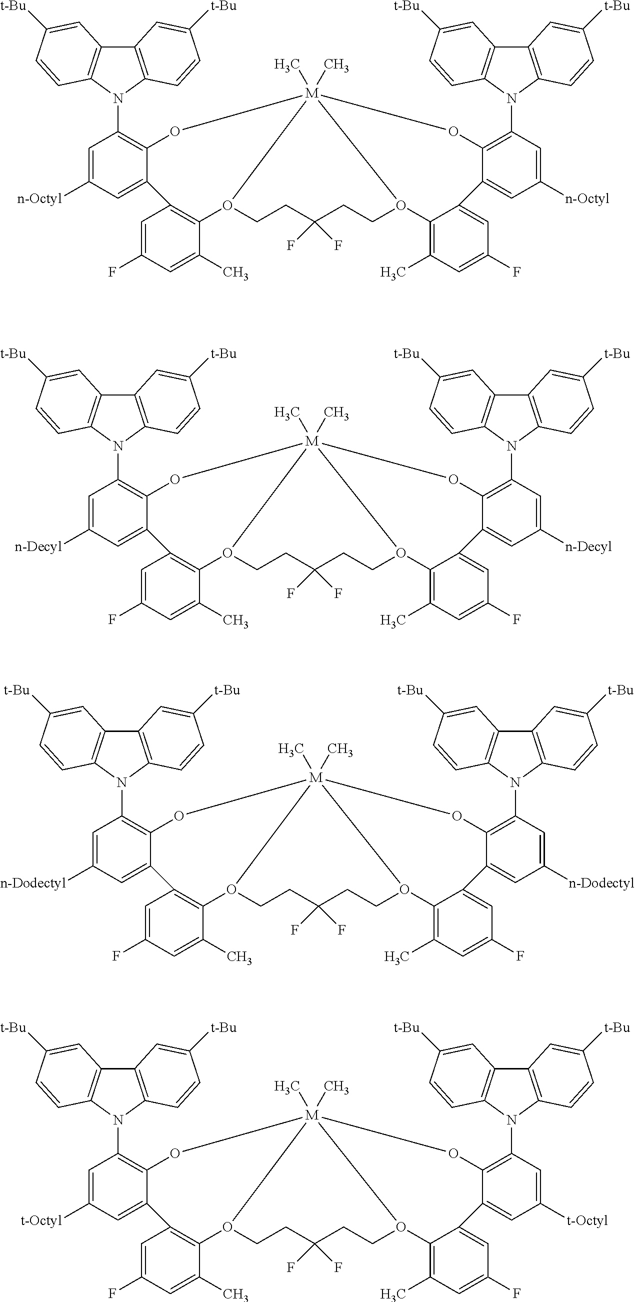

wherein M is zirconium or hafnium.

In addition, the present invention provides a catalyst composition for preparing an ethylene-based polymer selected from an ethylene homopolymer or a copolymer of ethylene and α-olefin, containing the metal-ligand complex according to the present invention and the cocatalyst.

The cocatalyst according to an exemplary embodiment may be a boron compound cocatalyst, an aluminum compound cocatalyst, and a mixture thereof.

The cocatalyst according to an exemplary embodiment may be contained in an amount of 0.5 to 10,000 moles based on 1 mole of the metal-ligand complex, but the present is not limited thereto.

Examples of the boron compound that may be used as the cocatalyst include those known in U.S. Pat. No. 5,198,401, and specifically may be one or a mixture of two or more selected from compounds represented by the following Formulas A to C:

B(R²¹)₃ [Formula A]

[R²²]⁺[B(R²¹)₄]⁻ [Formula B]

[(R²³)_{w}ZH]⁺[B(R²¹)₄]⁻ [Formula C]
wherein
B is a boron atom; R²¹ is phenyl, wherein the phenyl may be further substituted with 3 to 5 substituents selected from a fluorine atom, C₁-C₂₀alkyl, C₁-C₂₀alkyl substituted with a fluorine atom, C₁-C₂₀alkoxy, and C₁-C₂₀alkoxy substituted with a fluorine atom; R²² is C₈-C₇ aromatic radical or a C₁-C₂₀alkylC₆-C₂₀aryl radical, or a C₆-C₂₀arylC₁-C₂₀ alkyl radical, for example, a triphenylmethylium radical; Z is a nitrogen or phosphorus atom; R²³ is a C₁-C₂₀alkyl radical or an anilinium radical substituted with two C₁-C₁₀ alkyls together with a nitrogen atom; and w is an integer from 2 or 3.

Preferred examples of the boron-based cocatalyst include triphenylmethylinium tetrakis(pentafluorophenyl)borate, tris(pentafluorophenyl)borane, tris(2,3,5,6-tetrafluorophenyl)borane, tris(2,3,4,5-tetrafluorophenyl)borane, tris(3,4,5-trifluorophenyl) borane, tris(2,3,4-trifluorophenyl)borane, phenylbis(pentafluorophenyl)borane, tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, phenylbis(pentafluorophenyl)borate, or tetrakis(3,5-bistrifluoromethylphenyl)borate. In addition, specific examples of their combination include ferrocenium tetrakis(pentafluorophenyl)borate, 1,1′-dimethylferrocenium tetrakis(pentafluorophenyl)borate, silver tetrakis(pentafluorophenyl)borate, triphenylmethylinium tetrakis(pentafluorophenyl)borate, triphenylmethylinium tetrakis(3,5-bistrifluoromethylphenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl)borate, N,N-dimethylanilinium tetrakis(pentafluorophenyl)borate, N,N-diethylanilinium tetrakis(pentafluorophenyl)borate, N,N-2,4,6-pentamethylanilinium tetrakis(pentafluorophenyl)borate, N,N-dimethylanilinium tetrakis(3,5-bistrifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, or tri(dimethylphenyl)phosphonium tetrakis(pentafluorophenyl)borate, the most preferred of which may be any one or two or more selected from triphenylmethylinium tetrakis(pentafluorophenyl)borate, N,N-dimethylanilinium tetrakispentafluorophenylborate, triphenylmethylinium tetrakispentafluorophenylborate, and trispentafluoroborane.

Examples of an aluminum compound that may be used as a cocatalyst in the catalyst composition according to an exemplary embodiment of the present invention include an aluminoxane compound of formula D or E, an organoaluminum compound of formula F, or an organoaluminum alkyloxide or organoaluminum aryloxide compound of formula G or H:

(—Al(R³¹)—O—)ₓ [Formula D]

(R³¹)₂Al—(—O(R³¹)—)_{y}—(R³¹)₂ [Formula E]

(R³²)_{z}Al(E)_{3-z} [Formula F]

(R³³)₂AlOR³⁴ [Formula G]

R³³Al(OR³⁴)₂[Formula H]
wherein
R³¹ is C₁-C₂₀alkyl, preferably methyl or isobutyl, and x and y are each independently an integer from 5 to 20; R³² and R³³ are each independently C₁-C₂₀alkyl; E is a hydrogen atom or a halogen atom; z is an integer from 1 to 3; and R³⁴ is C₁-C₂₀alkyl or C₆-C₃₀aryl.

Specific examples which may be used as the aluminum compound includes methylaluminoxane, modified methylaluminoxane, and tetraisobutylaluminoxane as an aluminoxane compound; and trialkylaluminum including trimethylaluminum, triethylaluminum, tripropylaluminum, triisobutylaluminum and trihexylaluminum; dialkylaluminumchloride including dimethylaluminumchloride, diethylaluminumchloride, dipropylaluminum chloride, diisobutylaluminumchloride and dihexylaluminumchloride; alkylaluminumdichloride including methylaluminumdichloride, ethylaluminumdichloride, propylaluminumdichloride, isobutylaluminumdichloride and hexylaluminumdichloride; dialkylaluminum hydride including dimethylaluminum hydride, diethylaluminum hydride, dipropylaluminum hydride, diisobutylaluminum hydride, and dihexylaluminum hydride; and alkyl alkoxy aluminum including methyldimethoxyaluminum, dimethylmethoxyaluminum, ethyldiethoxyaluminum, diethylethoxyaluminum, isobutyldibutoxyaluminum, diisobutylbutoxyaluminum, hexyldimethoxyaluminum, dihexylmethoxyaluminum and dioctylmethoxyaluminum as an organic aluminum compound. Preferably, an aluminoxane compound, trialkylaluminum, and a mixture thereof may be used as a cocatalyst, specifically, methylaluminoxane, improved methylaluminoxane, tetraisobutyldialuminoxane, trimethylaluminum, triethylaluminum, and triisobutylaluminum alone or a mixture thereof may be used, and more preferably, tetraisobutyldialuminoxane, triisobutylaluminum, or a mixture thereof may be used.

Preferably, in the catalyst composition according to an exemplary embodiment of the present invention, when the aluminum compound is used as a cocatalyst, a ratio between the transition metal (M):the aluminum atom (Al) in the metal-ligand complex according to the present invention and the aluminum compound cocatalyst may be preferably in the range of 1:10 to 10,000 based on the molar ratio.

Preferably, in the catalyst composition according to an exemplary embodiment of the present invention, when both the aluminum compound and the boron compound are used as cocatalysts, a ratio of transition metal (M):boron atom (B):aluminum atom (Al) in the metal-ligand complex according to the present invention and the cocatalyst may be in the range of 1:0.1 to 200:10 to 10,000, and more preferably in the range of 1:0.5 to 100:25 to 5,000 based on the molar ratio.

The ratio between the metal-ligand complex according to the present invention and the cocatalyst exhibits excellent catalytic activity for preparing an ethylene-based polymer within the above range, and the range of the ratio varies depending on the purity of the reaction.

As another aspect according to an exemplary embodiment of the present invention, the preparation method of an ethylene-based polymer using the catalyst composition for preparing an ethylene-based polymer may be carried out by contacting the metal-ligand complex, a cocatalyst, and ethylene or, if necessary, a comonomer in the presence of an appropriate organic solvent. In this case, a procatalyst, which is a transition metal compound and the cocatalyst component may be separately injected into a reactor, or may be injected into the reactor by mixing each component in advance, and there is no limitation on mixing conditions such as the order of introduction, temperature, or concentration.

Preferred organic solvents which may be used in the above preparation method are C₃-C₂₀ hydrocarbons, and specific examples thereof include butane, isobutane, pentane, hexane, heptane, octane, isooctane, nonane, decane, dodecane, cyclohexane, methylcyclohexane, benzene, toluene, xylene, etc.

Specifically, when an ethylene homopolymer is prepared, ethylene is used alone as a monomer, and when a copolymer of ethylene and α-olefin is prepared, C₃-C₁₈ α-olefin may be used as a comonomer together with ethylene. Specific examples of the C₃-C₁₈ α-olefin include propylene, 1-butene, 1-pentene, 4-methyl-1-pentene, 1-hexene, 1-octene, 1-decene, 1-dodecene, 1-hexadecene, 1-octadecene, etc. In the present invention, the C₃-C₁₈ α-olefin as described above may be homopolymerized with ethylene, or two or more types of olefins may be copolymerized, and more preferably, 1-butene, 1-hexene, 1-octene, or 1-decene may be copolymerized with ethylene.

The pressure of ethylene may be 1 to 1,000 atm, more preferably 10 to 150 atm. In addition, it is effective that the polymerization reaction is carried out at 80° C. or more, preferably at 100° C. or more, and more preferably at 100° C. to 250° C. The temperature and pressure conditions in the polymerization step may be determined in consideration of the efficiency of polymerization reaction according to a type of reaction and a type of reactor to be applied.

In general, when the solution polymerization process is carried out at a high temperature as described above, as the temperature rises, deformation or deterioration of the catalyst occurs and the activity of the catalyst is lowered, making it difficult to obtain a polymer having desired properties. However, when an ethylene-based polymer is prepared using the catalyst composition according to the present invention, it exhibits stable catalytic activity at a high polymerization temperature.

The ethylene-based polymer is an ethylene homopolymer or a copolymer of ethylene and α-olefin, and the copolymer of ethylene and α-olefin contains 50% by weight or more of ethylene, preferably 60% by weight or more of ethylene, and more in the range of 60 to 99% by weight of ethylene.

As described above, a low density and low molecular weight ethylene homopolymer or a copolymer of ethylene and α-olefin may be prepared by using the metal-ligand complex according to the present invention as a main catalyst for polymerization.

For example, the ethylene-based polymer prepared according to the present invention is a low-density ethylene homopolymer or a copolymer of ethylene and α-olefin, and may have a low density of less than 0.870 g/cc, preferably a density of 0.850 g/cc or more and less than 0.870 g/cc, and at the same time exhibit a melt index (MI) value of 10 to 50 g/10 min (ASTM D1238, 190° C./2.16 kg).

In addition, in order to adjust a molecular weight in the preparation of the ethylene-based copolymer according to the present invention, hydrogen may be used as a chain transfer agent, and the ethylene copolymer usually has a weight average molecular weight (Mw) in a range of 50,000 to 200,000 g/mol.

Since the catalyst composition presented in the present invention is present in a homogeneous form in a polymerization reactor, it is preferred to apply to a solution polymerization process which is carried out at a temperature equal to or more than a melting point of the polymer. However, as disclosed in U.S. Pat. No. 4,752,597, the catalyst composition may also be used in a slurry polymerization or gas phase polymerization process in the form of a non-uniform catalyst composition obtained by supporting the procatalyst, which is a transition metal compound and the cocatalyst on a porous metal oxide support.

Hereinafter, the present invention will be described in detail by the following examples, however, the scope of the present invention is not limited thereto.

Unless otherwise stated, all experiments of synthesizing ligands and catalysts were carried out using a standard Schlenk or glove box technology under a nitrogen atmosphere and an organic solvent used in the reaction was refluxed under a sodium metal and benzophenone to remove moisture, and used after being distilled immediately before use. ¹H NMR analysis of the synthesized ligand and catalyst was carried out using a Bruker 400 or 500 MHz at room temperature.

Methylcyclohexane, which is a polymerization solvent, was used after being passed through a tube filled with a 5 Å molecular sieve and activated alumina and bubbling with high-purity nitrogen to sufficiently remove moisture, oxygen and other catalyst poison substances.

### [Example 1] Synthesis of Procatalyst C1

### Preparation of Compound 1-1 (3,6-di-tert-butyl-9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-9H-carbazole)

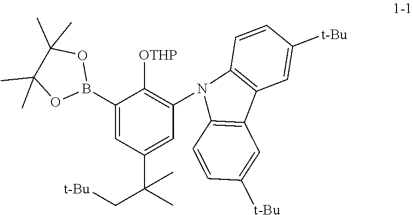

According to WO 2017/040088, the compound 1-1 (3,6-di-tert-butyl-9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-9H-carbazole) was prepared.

### Preparation of Compound 1-2 (2,2-difluoropropane-1,3-diyl bis(4-methylbenzenesulfonate))

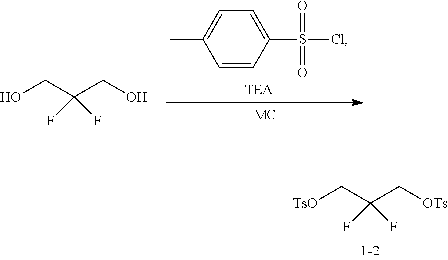 [SMILES: Cc1ccc(S(=O)(=O)Cl)cc1 ; OCC(F)(F)CO ; Cc1ccc(S(=O)(=O)OCC(F)(F)COS(=O)(=O)c2ccc(C)cc2)cc1]

2,2-difluoropropane-1,3-diol (44.6 mmol, 5 g) and 4-methylbenzene-1-sulfonyl chloride (18.71 g, 2.2 equiv.) were dissolved in DCM(Dichloromethane) (50 mL). After triethylamine (14 mL, 3 equiv.) was added at 0° C., the mixture was stirred overnight at room temperature (RT). After completion of the reaction, washing was performed using 1M NaOH, and the organic layer was extracted with DCM. After removal of the solvent, recrystallization was performed from hexane to obtain Compound 1-2 in the form of a white solid (17 g, 75%).

¹H NMR (CDCl₃): δ 7.76 (d, 4H), 7.37 (d, 4H), 4.18 (t, 4H), 2.46 (s, 6H).

### Synthesis of Compound 1-3 (4,4′-((2,2-difluoropropane-1,3-diyl)bis(oxy))bis(3-bromo-1-fluorobenzene))

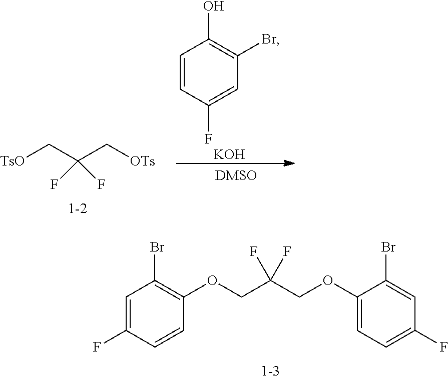

Compound 1-2 (11.89 mmol, 5 g), 2-bromo-4-fluorophenol (4.77 g, 2.1 equiv.), and KOH (1.67 g, 2.5 equiv.) were dissolved in DMSO (50 mL) and then stirred at 100° C. overnight. After completion of the reaction, the organic layer was extracted with DCM. After removal of the solvent, recrystallization was performed from hexane to obtain Compound 1-3 in the form of a white solid (4 g, 74%).

¹H NMR (CDCl₃): δ 7.29-7.26 (m, 2H), 7.00-6.99 (m, 2H), 6.94-6.92 (m, 2H), 4.24 (m, 4H).

### Synthesis of Ligand L1

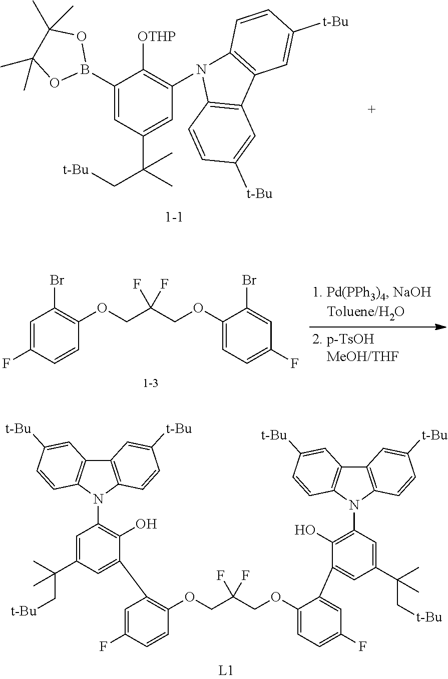

Compound 1-1 (7.0 g, 2.2 equiv.), compound 1-3 (2 g), NaOH (1.4 g, 8 equiv.), and Pd(pph₃)₄ (0.2 g, 0.04 equiv.) were added to a two-neck round bottom flask under a nitrogen atmosphere, dissolved in toluene (50 mL) and H₂O (10 mL), and stirred at 130° C. for 24 hours. After completion of the reaction, an organic material was extracted with EA to remove the solvent, and then purified by a filter column. The purified product was dissolved in THF (20 mL) and MeOH (20 mL). P-TsOH (0.08 g, 0.1 equiv.) was added thereto, followed by stirring at 60° C. for 4 hours. After completion of the reaction, the solvent was removed. Recrystallization was performed using MeOH to obtain ligand L1 in the form of a white solid (4.3 g, 78%).

¹H NMR (CDCl₃): δ 8.26 (m, 4H), 7.45 (d, 4H), 7.31 (d, 2H), 7.14 (d, 2H), 6.98 (d, 4H), 6.84-6.81 (m, 2H), 6.13-6.11 (m, 2H), 5.24 (m, 2H), 4.63 (s, 2H), 3.77 (m, 2H), 1.66 (s, 4H), 1.48 (s, 36H), 1.31 (s, 12H), 0.75 (s, 18H).

### Synthesis of Procatalyst C1

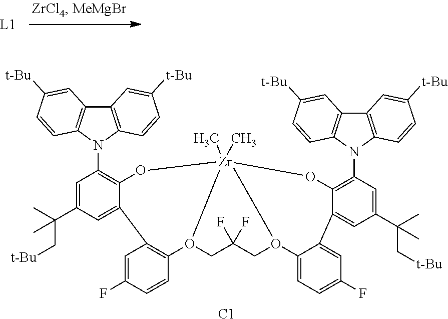

The reaction was carried out in a glove box under a nitrogen atmosphere. ZrCl₄ (0.66 g, 2.83 mmol) and toluene (200 mL) were added to a 100 ml flask to prepare a slurry. The slurry was cooled to −20° C. for 30 minutes in a glove box freezer. To the stirring cold slurry was added 3.0 M methylmagnesium bromide (3.9 mL, 15.3 mmol) in diethyl ether. The mixture was stirred vigorously for 30 minutes. The solid dissolved, but the reaction solution turned pale brown. To the mixture was slowly added ligand L1 (3.09 g, 2.44 mmol) as a solid. The reaction flask was heated to room temperature and stirred for 12 hours, and then the reaction mixture was filtered through a syringe to which a membrane filter was connected. The filtered solution was dried in vacuo to obtain procatalyst C1 as a brown solid (2.99 g, 88.7% yield).

¹H NMR (CDCl₃): δ 8.31 (s, 2H), 8.07 (s, 2H), 7.58-7.14 (m, 12H), 7.00 (m, 2H), 6.29 (m, 2H), 4.65 (m, 2H), 4.20 (m, 2H), 3.49 (m, 2H), 1.75 (s, 4H), 1.57 (s, 18H), 1.40 (s, 6H), 1.38 (s, 18H), 1.33 (s, 6H), 0.80 (s, 18H), −1.50 (s, 6H).

### [Comparative Example 1] Synthesis of Procatalyst C2

The procatalyst C2 was prepared according to WO 2017/040088 and KR 10-2019-0075778 A.

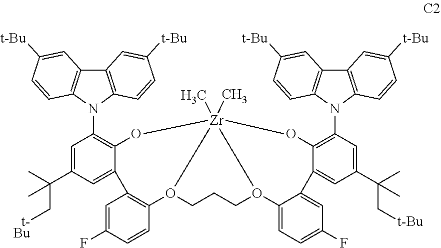

### [Comparative Example 2] Procatalyst C3

Procatalyst C3 having the following structure was obtained from S-PCI and used.

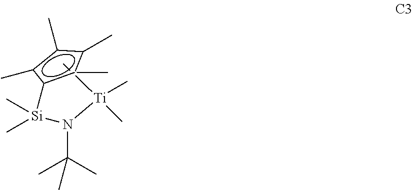

### [Example 2] Copolymerization of ethylene and 1-octene

Copolymerization of ethylene and 1-octene was carried out using a batch polymerization apparatus as follows.

After sufficiently drying, 600 mL of methylcyclohexane and 50 mL of 1-octene were added to a 1,500 mL stainless steel reactor substituted with nitrogen, and then 2 mL of triisobutylaluminum (1.0 M hexane solution) was added to the reactor. Thereafter, after heating the temperature of the reactor to 100° C., 1.0 μmol of the procatalyst C1 prepared in Example 1 and 40 μmol of triphenylmethylinium tetrakis(pentafluorophenyl) borate were sequentially added thereto, the pressure in the reactor was filled with ethylene to 20 bar, and then the feed was continuously performed to allow polymerization. After the reaction was allowed to proceed for 5 minutes, the recovered reaction product was dried in a vacuum oven at 40° C. for 8 hours. The polymerization results are shown in Table 1 below.

Melt flow index (MI, melt index): It was measured under a load of 2.16 kg at 190° C. using an ASTM D1238 analysis method.

Density: It was measured by an ASTM D792 analysis method.

### Comparative Example 3

Copolymerization of ethylene and 1-octene was carried out in the same manner as in Example 2, except that 1.0 μmol of procatalyst C2 (Comparative Example 2) was used instead of procatalyst C1 (Example 1). The polymerization reaction conditions and polymerization results are shown in Table 1 below.

### Comparative Example 4

Copolymerization of ethylene and 1-octene was carried out in the same manner as in Example 2, except that 1.0 μmol of procatalyst C3 (Comparative Example 2) was added instead of procatalyst C1 (Example 1). The polymerization reaction conditions and polymerization results are shown in Table 1 below.

TABLE 1

| | | | Catalyst activity | Polymer | |
|---|---|---|---|---|---|
| | Metal-ligand | ΔT | (kg/mmol of amount | Density | |
| Polymerization | complex | (° C.) | of catalyst used) | (g/cc) | MI |
| Example 2 | Procatalyst C1 | 35.1 | 78.2 | 0.860 | 31.04 |
| | (Example 1) | | | | |
| Comparative | Procatalyst C2 | 32.0 | 66.8 | 0.881 | 0.14 |
| Example 3 | (Comparative | | | | |
| | Example 1) | | | | |
| Comparative | Procatalyst | 26.3 | 44.3 | 0.889 | 3.03 |
| Example 4 | C3(Comparative | | | | |
| | Example 2) | | | | |

*Polymerization catalyst: a molar ratio of triphenylmethylinium tetrakis(pentafluorophenyl)borate:triisobutyl aluminum = 1:40:2,000

From the polymerization results in Table 1, it can be confirmed that catalyst activity and polymer properties are significantly different due to the structure of the polymerization catalyst.

Specifically, in the case of Example 2 using the procatalyst C1 (Example 1) of the present invention as a polymerization catalyst, it can be seen that the catalytic activity is significantly improved, and a copolymer of ethylene and 1-octene having a high MI value indicating low density and low molecular weight may be prepared, compared to the case of Comparative Example 3 using the procatalyst C2 (Comparative Example 1) having no fluoride at the same position and Comparative Example 4 using the procatalyst C3, which is the metallocene compound (Comparative Example 2).

That is, it can be seen that when the procatalyst C1 according to the present invention is used, the MI value is significantly increased compared to the procatalysts C2 and C3 of Comparative Examples, and from the above results, it can be seen that the copolymer prepared by using the metal-ligand complex according to the present invention as a polymerization catalyst has a lower molecular weight than those of Comparative Examples.

In addition, when the procatalyst C1 according to the present invention was used, the density was 0.860 g/cc, from which it can be seen that, unlike the procatalysts C2 and C3 of the Comparative Examples, it had a low density of less than 0.870 g/cc.

It can be seen that whether such a low-density and low-molecular-weight copolymer is prepared is due to the structural characteristics of the polymerization catalyst.

Therefore, the metal-ligand complex according to the present invention may have surprisingly excellent catalytic activity even at a high temperature due to the difluoromethyl-bridged structural characteristic as a bulky electron-withdrawing group, and may effectively prepare a low density and low molecular weight copolymer of ethylene and α-olefin, thereby being useful for developing high value-added products.

As described above, though the present invention has been described in detail with respect to the exemplary embodiments thereof, a person skilled in the art may make various variations of the present invention without departing from the scope of the present invention, as defined in the claims which follow. Therefore, further modifications in the embodiments of the present invention will not deviate from the technology of the present invention.

1. A metal-ligand complex represented by the following Formula 1: 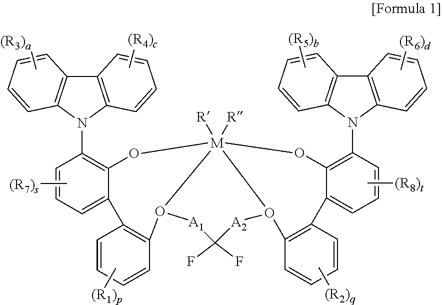
wherein
M is a transition metal of Group 4 in the periodic table;
A₁ and A₂ are each independently C₁-C₂₀alkylene or C₁-C₂₀haloalkylene;
R′ and R″ are each independently C₁-C₂₀alkyl, C₆-C₂₀aryloxy, or C₁-C₂₀alkylC₆-C₂₀aryloxy;
R₁ and R₂ are each independently halogen, C₁-C₂₀alkyl, or haloC₁-C₂₀alkyl;
R₃ to R₆ are each independently C₁-C₂₀alkyl, C₆-C₂₀aryl, or C₆-C₂₀arylC₁-C₂₀alkyl;
R₇ and R₈ are each independently C₁-C₂₀alkyl or C₁-C₂₀alkoxy;
p, q, a, b, c, and d are each independently an integer from 0 to 4; and
s and t are each independently an integer from 0 to 3.

2. The metal-ligand complex of claim 1, wherein
in Formula 1,
A₁ and A₂ are each independently C₁-C₂₀alkylene;
R′ and R″ are each independently C₁-C₂₀alkyl;
R₁ and R₂ are each independently halogen, C₁-C₂₀alkyl, or haloC₁-C₂₀alkyl;
R₃ to R₆ are each independently C₁-C₂₀alkyl or C₆-C₂₀arylC₁-C₂₀alky;
R₇ and R₈ are each independently C₁-C₂₀alkyl or C₁-C₂₀alkoxy;
p and q are each independently an integer from 0 to 3;
a, b, c, and d are each independently an integer from 1 to 3; and
s and t are each independently an integer from 1 to 2.

3. The metal-ligand complex of claim 1, wherein
Formula 1 is represented by the following Formula 2: 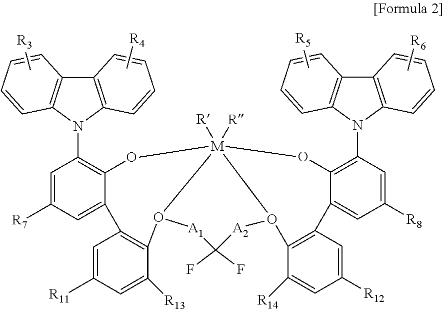
wherein
M is a transition metal of Group 4 in the periodic table;
A₁ and A₂ are each independently C₁-C₂₀alkylene or C₁-C₂₀haloalkylene;
R′ and R″ are each independently C₁-C₂₀alkyl, C₆-C₂₀aryloxy, or C₁-C₂₀alkylC₆-C₂₀aryloxy;
R₃ to R₆ are each independently C₁-C₂₀alkyl, C₆-C₂₀aryl, or C₆-C₂₀arylC₁-C₂₀alkyl;
R₇ and R₈ are each independently C₁-C₂₀alkyl or C₁-C₂₀alkoxy;
R₁₁ and R₁₂ are each independently hydrogen, halogen, or C₁-C₂₀alkyl; and
R₁₃ and R₁₄ are each independently hydrogen or C₁-C₂₀alkyl.

4. The metal-ligand complex of claim 3, wherein
in Formula 2,
A₁ and A₂ are each independently C₁-C₂₀alkylene;
R′ and R″ are each independently C₁-C₂₀alkyl;
R₃ to R₆ are each independently C₁-C₂₀alkyl or C₆-C₂₀arylC₁-C₂₀alkyl;
R₇ and R₈ are each independently C₁-C₂₀alkyl or C₁-C₂₀alkoxy;
R₁₁ and R₁₂ are each independently halogen; and
R₁₃ and R₁₄ are each independently hydrogen or C₁-C₂₀alkyl.

5. The metal-ligand complex of claim 1, wherein
Formula 1 is represented by the following Formula 3: 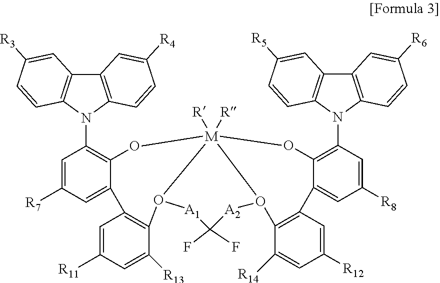
wherein
M is titanium, zirconium, or hafnium;
A₁ and A₂ are each independently C₁-C₂₀alkylene or C₁-C₂₀haloalkylene;
R′ and R″ are each independently C₁-C₂₀alkyl;
R₃ to R₆ are each independently C₁-C₂₀alkyl;
R₇ and R₈ are each independently C₁-C₂₀alkyl or C₁-C₂₀alkoxy;
R₁₁ and R₁₂ are each independently halogen; and
R₁₃ and R₁₄ are each independently hydrogen or C₁-C₂₀alkyl.

6. The metal-ligand complex of claim 5, wherein
in Formula 3,
A₁ and A₂ are each independently C₁-C₁₀alkylene;
R′ and R″ are each independently C₁-C₁₀alkyl;
R₃ to R₆ are each independently C₁-C₁₀alkyl;
R₇ and R₈ are each independently C₅-C₂₀alkyl or C₅-C₂₀alkoxy;
R₁₁ and R₁₂ are each independently halogen; and
R₁₃ and R₁₄ are each independently hydrogen or C₁-C₁₀alkyl.

7. The metal-ligand complex of claim 1, wherein
Formula 1 is represented by the following Formula 4: 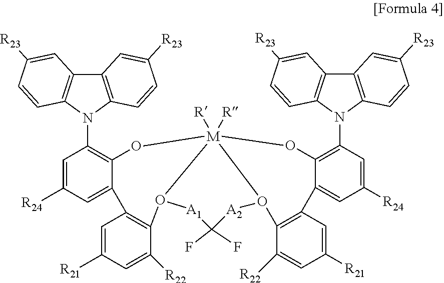
wherein
M is titanium, zirconium, or hafnium;
A₁ and A₂ are each independently C₁-C₂₀alkylene or C₁-C₂₀haloalkylene;
R is C₁-C₂₀alkyl;
R₂₁ is halogen;
R₂₂ is hydrogen or C₁-C₂₀alkyl;
R₂₃ is C₁-C₂₀alkyl; and
R₂₄ is C₁-C₂₀alkyl or C₁-C₂₀alkoxy.

8. A catalyst composition for preparing an ethylene-based polymer, comprising:
the metal-ligand complex of claim 1; and
a cocatalyst.

9. The catalyst composition for preparing an ethylene-based polymer of claim 8, wherein
the cocatalyst is an aluminum compound cocatalyst, a boron compound cocatalyst, or a mixture thereof.

10. The catalyst composition for preparing an ethylene-based polymer of claim 8, wherein
the cocatalyst is used in an amount of 0.5 to 10,000 moles based on 1 mole of the metal-ligand complex.

11. A preparation method of an ethylene-based polymer, comprising: preparing an ethylene-based polymer by polymerizing ethylene or ethylene and α-olefin in the presence of the catalyst composition for preparing an ethylene-based polymer of claim 8.

12. The preparation method of an ethylene-based polymer of claim 11, wherein
the polymerization is carried out at 100 to 250° C.
